(19) United States
(12) Patent Application Publication
(10) Pub. No.: US 2018/0085764 A1
(43) Pub. Date: Mar. 29, 2018

(54) FLOW RESTRICTION DEVICE AND SANITARY SHOWER

(71) Applicant: HANSGROHE SE, Schiltach (DE)

(72) Inventor: Arthur Klassen, Fluorn-Winzeln (DE)

(73) Assignee: HANSGROHE SE, Schiltach (DE)

(21) Appl. No.: 15/715,362

(22) Filed: Sep. 26, 2017

(30) Foreign Application Priority Data
Sep. 29, 2016 (DE) 10 2016 218 917.4

(51) Int. Cl. B05B 1/30; E03C 1/04; B05B 1/18

(52) U.S. Cl. CPC B05B 1/30; E03C 2001/026; B05B 1/185; E03C 1/0408

(57) ABSTRACT

A flow restriction device and/or a sanitary shower equipped with the flow restriction device includes a restrictor body composed of multiple web planes disposed successively in an axial direction and filling a passage cross-section of the restrictor body perpendicular to the axial direction. Each web plane is composed of a plurality of webs extending mutually in parallel and perpendicular to the axial direction, spaced from each other thereby leaving web intermediate gaps. Webs of two directly adjoining web planes extend non-parallel to each other. The device is useful in overhead showers, for example, and limits noise.

The invention relates to a flow restriction device and to a sanitary shower which is fittable with a flow restriction device and has a shower inlet region with a shower inlet, a shower outlet region with a shower outlet, and a water passageway from the shower inlet to the shower outlet.

It is known, for example, in the case of water-conducting sanitary installations, such as showers and fittings mounted upstream of the latter and also bath tub and wash basin fittings, to take flow-regulating or throughflow-limiting measures. In addition, it is endeavoured to minimize the production of noise caused by the water flow when water flows through said installations during operation. These include quantity regulators which are used in the inflow region of showers and other sanitary fittings for the purpose of regulating the quantity of water flowing therethrough, and conduit curvatures, typical sources for undesirably severe flow noises. In addition, flow noises which occur can be amplified to an annoying extent by structure-borne sound.

It is an object of the invention to provide a flow restriction device which can be used in a noise-reducing manner and, if the need arises, also in a through-flow-reducing manner. It is a further objection of the invention to provide a sanitary shower fitted with said flow restriction device.

The invention achieves these and other objects by providing a novel flow restriction device and a novel sanitary shower.

The flow restriction device according to the invention comprises a restrictor body composed of a plurality of web planes disposed successively in an axial direction of the restrictor body. The web planes each fill a passage cross-section of the restrictor body perpendicular to the axial direction, i.e. each web plane extends beyond the entire passage cross-section of the restrictor body. Each web plane is composed of a plurality of webs extending mutually in parallel and perpendicular to the axial direction. The webs of a respective web plane are spaced apart from each other and thereby leave web intermediate gaps located in between. The webs of two directly adjoining web planes extend non-parallel to each other, i.e. extend intersected at a certain angle with respect to each other.

It has been shown that the flow restriction device according to the invention with this specific restrictor body structure can bring about highly effective sound throttling and therefore reduction in noise. The non-parallel rows of webs which lie one behind another in a plurality of planes in the flow direction and force the fluid to be repeatedly deflected act counter to high flow speeds of a fluid flowing therethrough. The structure of the restrictor body also results in a flow behaviour which acts to high extent in a sound-throttling or noise-reducing manner. The flow restriction device may be used, for example, as a sanitary flow restriction device in sanitary appliances.

In a development of the invention, the webs of two directly adjoining planes of web extend inclined to each other at an angle of at least 45°, preferably at an angle of at least 85°, wherein in particular a mutually perpendicular course can be provided. As a rule, the noise-reducing effect is increased with a greater crossing angle of the webs of two directly adjoining web planes.

In a development of the invention, the webs of respective next but one web planes extend in parallel and transversely offset. Transversely offset should be understood here as meaning that the web row of the one web plane is offset in relation to that of the other next but one web plane perpendicularly to the axial direction of the restrictor body and perpendicularly to the web-running direction. The webs of the one plane thus overlap at least partially with the web intermediate gaps of the other next but one web plane. This optimizes the restriction effect of the flow restriction device in respect of noise reduction and/or fluid throughflow quantity. In particular, it can be provided that the webs of the one plane lie, as seen in a projection of the axial direction, completely within the web intermediate gaps of the other next but one web plane or completely cover said web intermediate gaps, depending on the width of the webs, on the one hand, and the web intermediate gaps, on the other hand.

In a development of the invention, all of the webs of all of the web planes have a substantially uniform, identical width, and the width of the web intermediate gaps, which is preferably also substantially identical for all of the intermediate gaps, varies by at most 10% from the width of the webs. This means that the distance between adjacent webs in the respective web plane substantially corresponds to the width of the webs. In an advantageous realization, the webs of respective next but one web planes can be transversely offset in parallel and with respect to one another by the web width, and therefore the webs of the one plane, as seen in a projection of the axial direction of the restrictor body, then substantially completely cover the web intermediate gaps of the other next but one web plane. A restrictor body constructed in such a manner is advantageous in terms of manufacturing and with respect to the noise/throughflow-restricting effect.

In a development of the invention, at least two directly adjoining web planes are formed by a one-piece restrictor element. This permits a comparatively simple production of the flow restriction devices.

In a refinement of the invention, the restrictor body is composed of a plurality of such one-piece restrictor elements stacked in the axial direction, each including at least two of the web planes. This is also an advantageous measure from manufacturing aspects. The individual restrictor elements here can all have an identical number of web planes or, alternatively, can differ in their number of web planes.

In a further refinement of the invention, the stacked restrictor elements include connecting means or a connecting arrangement, interconnecting said elements in a releasable or non releasable manner. This permits manufacturing of the restrictor body by the fact that first of all the one-piece restrictor elements are produced and the latter are then assembled to form the restrictor body.

In a further refinement of the invention, the connecting means or arrangement comprises a releasable snap-on connecting structure. This can be of advantage in terms of manufacturing and functionally and, when the need arises, permits destruction-free removal of the restrictor body in the individual one-piece restrictor elements.

In the case of the sanitary shower according to invention, the flow restriction device according to the invention is disposed within the water passageway from the shower inlet to the shower outlet. As a result, the production of noise of the sanitary shower can be restricted or reduced, and, when the need arises, the flow restriction device can also provide regulation of the throughflow or restriction of the throughflow of the quantity of water used by the sanitary shower.

In a development of the invention, the flow restriction device is disposed within a shower connecting body of the sanitary shower, wherein the shower connecting body includes the shower inlet region, and wherein a shower main body which is connected to the shower connecting body and includes the shower outlet region with the shower outlet, via which an associated shower jet is output, follows the shower connecting body in the flow direction. The shower main body can be, for example, a shower head of a flat overhead shower, said shower head being coupled pivotably, for example via a ball and socket joint, to the shower connecting body.

Advantageous embodiments of the invention are illustrated in the drawings and are described below. In the drawings:

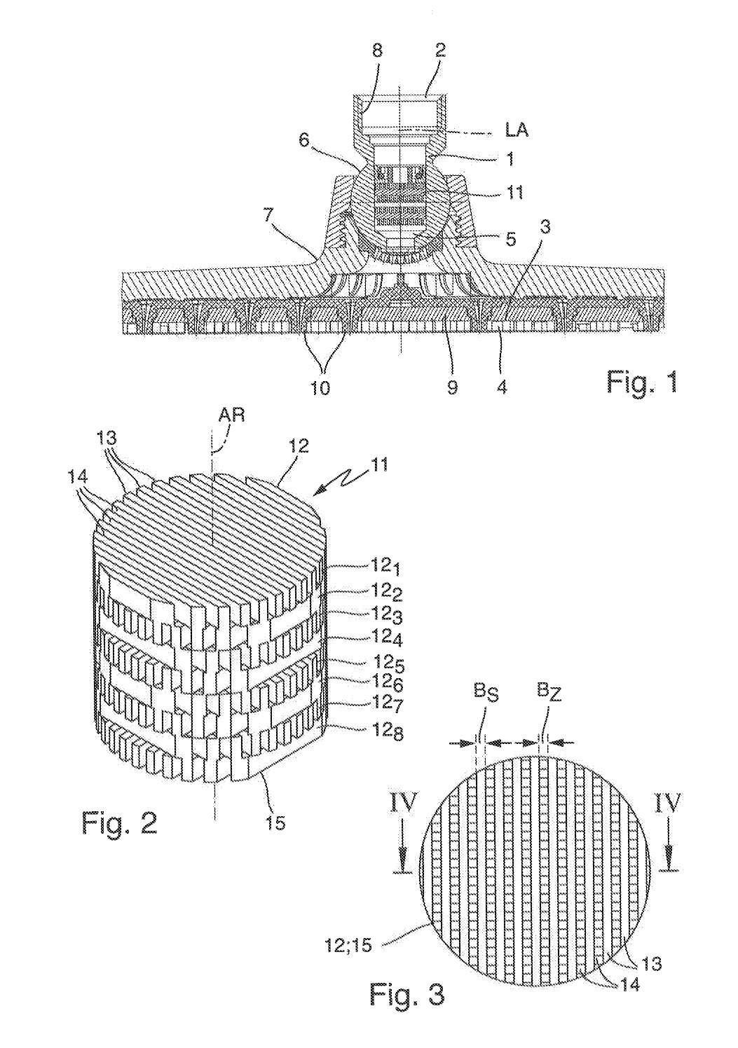

FIG. 1 shows a longitudinal sectional view of part of a sanitary shower,

FIG. 2 shows a perspective view of a flow restriction device fitted in the sanitary shower of FIG. 1,

FIG. 3 shows a top view of the flow restriction device of FIG. 2,

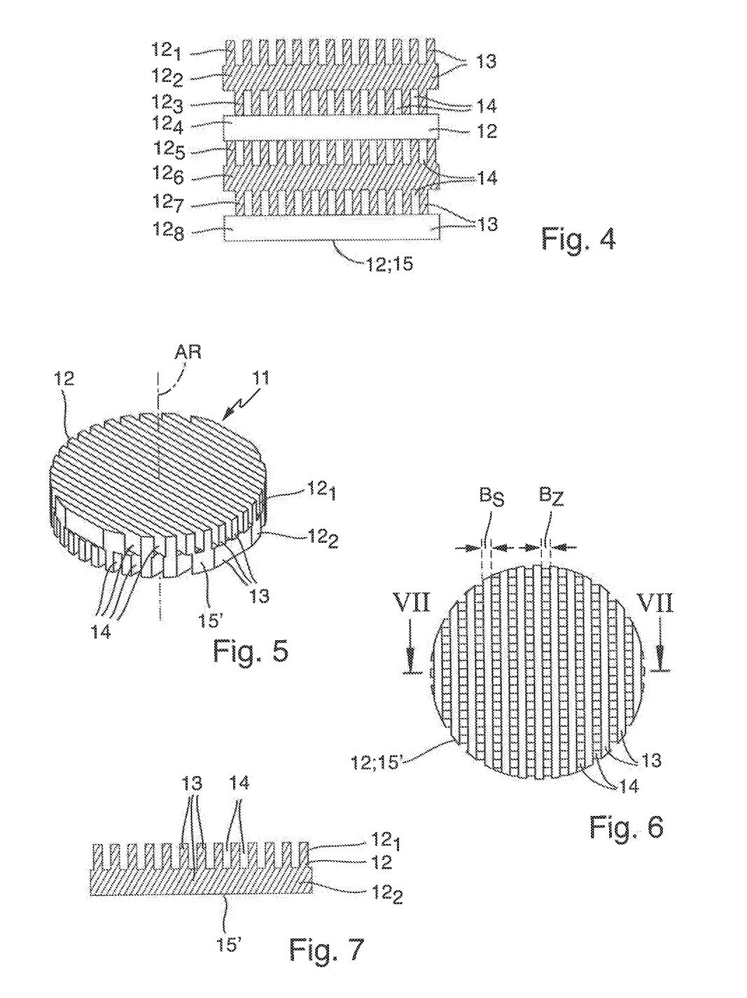

FIG. 4 shows a sectional view along the line IV-IV in FIG. 3,

FIG. 5 shows a perspective view of a further flow restriction device,

FIG. 6 shows a top view of the flow restriction device of FIG. 5,

FIG. 7 shows a sectional view along a line VII-VII of FIG. 6,

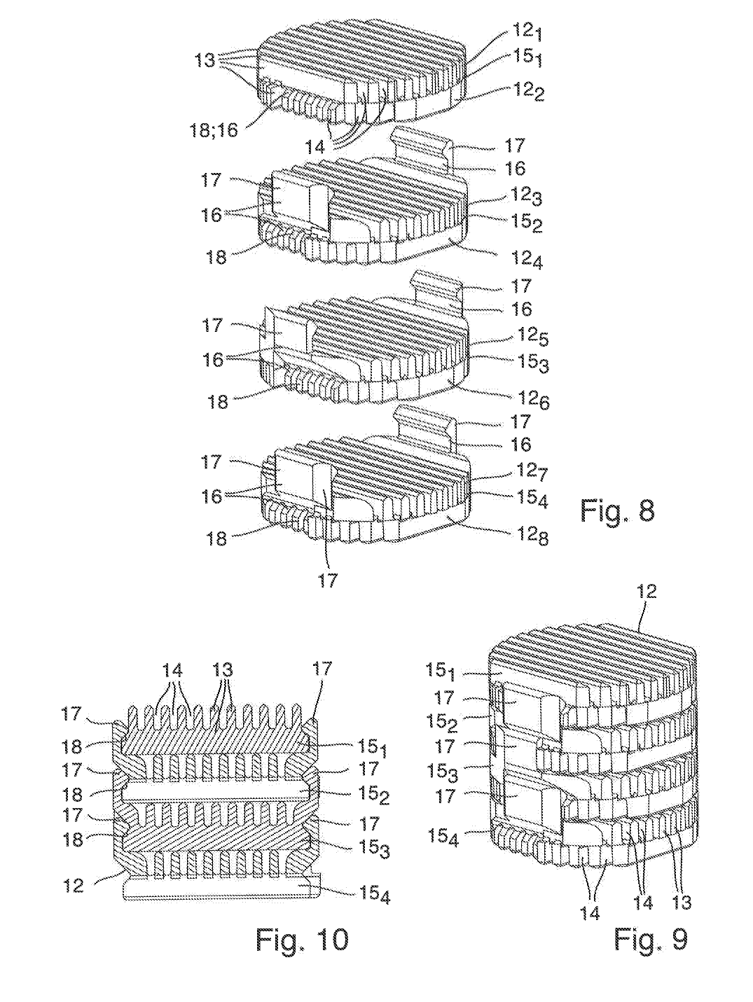

FIG. 8 shows a perspective exploded view of a further flow restriction device,

FIG. 9 shows a perspective view of the flow restriction device of FIG. 8 in the assembled state, and

FIG. 10 shows a longitudinal sectional view of the flow restriction device of FIGS. 8 and 9.

The sanitary shower of FIG. 1 comprises a shower inlet region 1 with a shower inlet 2 and a shower outlet region 3 with a shower outlet 4. A water passageway 5 leads from the shower inlet 2 to the shower outlet 4. Said sanitary shower can be used, for example, as a flat overhead shower of a shower system.

In the exemplary embodiment shown the shower inlet region 1 is formed by a shower connecting body 6 to which a shower main body 7 which comprises the shower outlet region 3 is connected. In the example shown, the connection is realized by means of a ball and socket joint 8, and therefore the shower main body 7 is correspondingly held pivotably on all sides on the shower connecting body 6 which, for its part, can be coupled via a connecting thread 8 to a customary water supply connection (not shown). The shower outlet region 3 can be formed, for example, by a customary one-piece or, as shown, multi-piece jet disc 9 with a plurality of jet outlet openings 10, which form the shower outlet 4, in order to provide a corresponding shower jet.

A flow restriction device 11, as illustrated individually in FIGS. 2 to 4, is disposed within the water passageway 5 and, in the exemplary embodiment shown, specifically in the shower connecting body 6. As is apparent therefrom, the flow restriction device 11 includes a restrictor body 12 which is formed from a plurality of web planes 12₁ to 12₈, in the example shown eight web planes. The web planes 12₁ to 12₈ are arranged adjoining one another in an axial direction AR, i.e. they lie in a stack-shaped manner one behind another or one above another in this direction AR. In the fitted state in the sanitary shower of FIG. 1 the axial direction AR of the restrictor body corresponds to the direction of a longitudinal axis LA of the shower. The axial direction AR of the restrictor body corresponds to the direction in which fluid, such as water, flows through the flow restriction device or the restrictor body 12 during operation. In the example shown, the restrictor body 12 has a round-cylindrical shape; in alternative embodiments, it has any other, for example oval or polygonal, cross-sectional form. Each web plane 12₁ to 12₈ fills said passage cross section of the restrictor body 12, said passage cross-section being circular in the example shown, perpendicular to the axial direction AR, i.e. it extends in each case over the entire passage cross-section.

Each web plane 12₁ to 12₈ is composed of a plurality of webs 13 extending mutually in parallel and perpendicular to the axial direction, the webs being spaced from each other thereby leaving web intermediate gaps 14, wherein the webs 13 of two directly adjoining web planes, such as 12₁ to 12₂, 12₂ and 12₃, etc., extend non-parallel to each other. The webs of two directly adjoining web planes preferably extend inclined to each other at an angle of at least 45°, in particular at least 85°. In the example shown, they extend perpendicular to each other. The webs 13 of each web plane 12₁ to 12₈ have a preferably identical axial height, i.e. web height which in turn defines the axial height of the respective web plane 12₁ to 12₈. Depending on the embodiment, the webs 13 of the respectively directly adjoining, i.e. adjacent, web planes, such as 12₁ and 12₂, etc., are in contact, or merge in one piece in each other or lie opposite each other at just a small axial distance, which is at most 1% to 10% of the web height.

In the example shown, all of the webs 13 of all of the web planes 12₁ to 12₈ have an identical width Bₛ, and all of the web intermediate gaps 14 also have an identical width B_{z}. In alternative embodiments, the webs of at least one web plane have different widths, and/or the webs of various web planes have different widths, and/or the web intermediate gaps of at least one web plane have different widths, and/or the web intermediate gaps of various web planes have different widths. The width B_{z} of the web intermediate gaps 14 preferably varies by at most 10% from the width Bₛ of the webs 13, and in particular the widths can be identical, i.e. B_{z}=Bₛ. In alternative embodiments, the width of the web intermediate gaps varies by more than 10% from the width of the webs. The web width Bₛ is preferably smaller than the web height; in corresponding embodiments, the web height has a value selected as desired from the range of twice to five times the web width Bₛ.

In corresponding embodiments, the webs 13 of respective next but one web planes, such as 12₁ and 12₃, 12₂ and 12₄, 12₃ and 12₅, 12₄ and 12₆, etc., extend in parallel and transversely offset. In the example shown, they extend in parallel and transversely offset by the web width Bₛ. This means that, as seen in projection of the axial direction AR, the webs 13 of the one web plane, for example 12₁ or 12₂, lie precisely in or above the web intermediate gaps 14 of the next but one web plane, for example 12₃ or 12₄, in particular in substantially identical widths Bₛ, B_{z} of the webs 13 and the web intermediate gaps 14. In this case, at the latest after four web planes, there are then no longer any free pass-through regions in the axial direction AR, i.e. the fluid is deflected/diverted through the restrictor body structure at every point of the passage cross-section of the restrictor body 12. In alternative embodiments, the webs of at least two next but one web planes extend non-parallel and/or without a transverse offset.

In the exemplary embodiment shown, the restrictor body 12 with its eight adjoining web planes 12₁ to 12₈ is formed by a one-piece restrictor element 15. The one-piece restrictor element 15 can be produced, for example, by an additive production process, such as a 3D printing technique. In alternative embodiments, the restrictor body 12 is assembled from a plurality of individual parts which are each manufactured separately and are subsequently joined together, for example, by adhesive bonding or welding. The restrictor body 12 is preferably composed of a plastic material, for example of a plastic material suitable for a 3D printing process or an injection moulding process.

It has been shown that the production of noise in the case of the sanitary shower of FIG. 1 can be significantly reduced by fitting the flow restriction device 11 and also structure-borne sound effects for the sanitary shower of FIG. 1, which is usable for example as an overhead shower, are also reduced here. The flow restriction device has a restricting effect on the flow speed of the supplied water and ensures a significant reduction in the water flow noise which could otherwise arise, inter alia, because of the relatively sharp deflection of the primarily axial course of flow in the shower inlet region 1 into a primarily radial adjoining course of flow in the shower outlet region 3 before entry into the jet outlet openings 10. In addition, the use of the flow restriction device 11 enables a customary quantity regulator to be used in the shower inlet region 1 if there is a need for this, without this resulting in an excessive production of noise.

In addition to the sound-restricting function, the flow restriction device 11, as mentioned, can carry out a function restricting the flow speed of the water flowing therethrough by the water passing therethrough, as explained, making one or more changes in direction at the web planes lying one behind another in the flow direction. By means of a corresponding choice of the number of adjoining web planes and of the web widths and the web distances within a respective web plane, the action of reducing the noise level and of restricting the flow can be set in a desired manner.

FIGS. 5 to 7 illustrate a minimal variant for the flow restriction device 11, in which the restrictor body 12 is formed from only the two web planes 12₁, 12₂. For easier understanding, the same reference numbers as in the embodiment according to FIGS. 2 to 4 are used for identical and functionally equivalent elements in the variant of FIGS. 5 to 7 and in the further variant of FIGS. 8 to 10, and reference can be made in respect of these elements and the properties and effects thereof to the above explanations with respect to FIGS. 2 to 4.

In the embodiment of FIGS. 5 to 7, the restrictor body 12 is again formed by a one-piece restrictor element 15′ which can be produced, for example, by means of an additive process, such as 3D printing, wherein alternatively other conventional manufacturing processes are usable. The webs 13 of the two web planes 12₁, 12₂ preferably extend perpendicularly to each other, as shown, and the webs 13 and the web intermediate gaps 14 here preferably also in each case have substantially identical widths Bₛ and B_{z}, respectively. For this purpose and otherwise, reference can be made to the above explanations with respect to the exemplary embodiment of FIGS. 2 to 4. The minimal variant of FIGS. 5 to 7 is usable in particular in cases in which even a relatively slight restricting effect suffices in respect of reducing noise and/or reducing flow.

FIGS. 8 to 10 illustrate a variant embodiment in which the restrictor body 12 is composed of a plurality of one-piece restrictor elements 15₁ to 15₄ stacked in the axial direction AR, each, like the restrictor element 15′ in the exemplary embodiment of FIGS. 5 to 7, including two web planes 12₁, 12₂ or 12₃, 12₄, etc.

The stacked restrictor elements 15₁ to 15₄ include connecting means 16, which can interconnect said elements. In this example, the connecting means 16 are releasable snap-on connecting means which, on two opposite sides on each restrictor element 15₁ to 15₄, include snap-on recesses 18 and, with the exception of the first or uppermost restrictor element 15₁, two corresponding, axially protruding snap-on lugs 17.

With the aid of said snap-on connection 16, the individual restrictor elements 15₁ to 15₄ can be stacked on one another and latched to one another in order to form the finished restrictor body 12, as shown in FIGS. 9 and 10. The snap-on lugs 17 of a respective restrictor element 15₂ to 15₄, said snap-on lugs being formed as spring tongues, snap here into the snap-on recesses 18 of the restrictor element 15₁ to 15₃ which is next in each case in the stack.

Each restrictor element 15₁ to 15₄ otherwise corresponds in construction and function to the restrictor element 15′ in the variant of FIGS. 5 to 7, in particular in respect of course and arrangement of the webs 13 and of the web intermediate gaps 14. In the variant of FIGS. 8 to 10, as is apparent in finished form in FIGS. 9 and 10, the restrictor body 12 composed of the four restrictor elements 15₁ to 15₄ therefore corresponds in structure and properties, in particular in respect of the web planes 12₄ to 12₈ with the webs 13 and the web intermediate gaps 14, to the restrictor body 12 in the realization of FIGS. 2 to 4. The sole difference is the production of the restrictor body 12 of FIGS. 8 to 10 from the four one-piece restrictor elements 15₁ to 15₄ instead of the one-piece restrictor element 15 in the realization of FIGS. 2 to 4 and the possibility of being able to disassemble the restrictor body 12 again, in the variant embodiment of FIGS. 8 to 10, into the individual restrictor elements 15₁ to 15₄. All that needs to be done for this is for the snap-on lugs 17 to be disengaged from the snap-on recesses 18. This permits an exchange of the respective restrictor element 15₁ to 15₄ if the need arises and may make it easier to clean the restrictor body 12.

A further advantage of the variant embodiment according to FIGS. 8 to 10 consists in being able to construct the restrictor body 12 with a freely selectable number of individual restrictor elements in the manner of the restrictor elements 15₁ to 15₄, depending on need and application, and therefore a restrictor body can be provided with any desired number of adjoining web planes. Otherwise, the properties and advantages mentioned with respect to the exemplary embodiments of FIGS. 1 to 7 apply in an analogous manner to the restrictor body 12 and the associated flow restriction device in the embodiment according to FIGS. 8 to 10.

In further embodiments (not shown) of the invention, sanitary showers different to that shown in FIG. 1, wherein, for example, different types of overhead showers or hand-held showers or side showers can be involved, are fitted with the flow restriction device according to the invention, wherein the latter is preferably arranged in the shower inlet region of the sanitary shower, but can alternatively also be fitted at a different location. In further alternative embodiments of the invention, the flow restriction device according to the invention, in one of the variant embodiments shown or in a different variant embodiment, is inserted into a different sanitary installation instead of in a sanitary shower, for example in mixer fittings and other water-conducting fittings and pipe sections of a bath tub and wash basin system or shower systems.

As the exemplary embodiments shown and explained above make clear, the invention provides a flow restriction device which can be manufactured in a particularly advantageous manner and can be used for reducing noise and/or restricting flow in fluid conducting installations, including in particular in sanitary showers.

What is claimed is:

1. A flow restriction device, comprising:
a restrictor body composed of a plurality of web planes disposed successively in an axial direction and filling a passage cross-section of the restrictor body perpendicular to the axial direction, wherein each said web plane is composed of a plurality of webs extending mutually in parallel and perpendicular to the axial direction, the webs being spaced from each other thereby leaving web intermediate gaps, and wherein the webs of two directly adjoining web planes extend non-parallel to each other.

2. The flow restriction device according to claim 1, wherein the webs of said two directly adjoining web planes extend inclined to each other at an angle of at least 45°.

3. The flow restriction device according to claim 1, wherein the webs of a respective next-but-one of the web planes extend in parallel with and are transversely offset from the webs of a given one of the web planes disposed successively in the axial direction.

4. The flow restriction device according to claim 1, wherein the webs of the web planes have an identical width and wherein a width of the web intermediate gaps varies by at most 10% from the width of the webs.

5. The flow restriction device according to claim 1, wherein at least two directly adjoining web planes in the axial direction are formed by a one-piece restrictor element.

6. The flow restriction device according to claim 5, wherein the restrictor body is composed of a plurality of one-piece restrictor elements stacked in the axial direction, each of the one-piece restrictor elements including at least two of the web planes.

7. The flow restriction device according to claim 6, wherein the stacked restrictor elements include a connecting, arrangement interconnecting said elements in a releasable manner.

8. The flow restriction device according to claim 7, wherein the connecting arrangement comprises a releasable snap-on connecting arrangement.

9. A sanitary shower, comprising:
a shower inlet region with a shower inlet,
a shower outlet region with a shower outlet,
a water passageway (5) from the shower inlet to the shower outlet, and
a flow restriction device disposed within the water passageway, said flow restriction device comprising a restrictor body composed of a plurality of web planes disposed successively in an axial direction and filling a passage cross-section of the restrictor body perpendicular to the axial direction, wherein each said web plane is composed of a plurality of webs extending mutually in parallel and perpendicular to the axial direction, the webs being spaced from each other thereby leaving web intermediate gaps, and wherein the webs of two directly adjoining web planes extend non-parallel to each other.

10. The sanitary shower according to claim 9, further comprising:
a shower connecting body including the shower inlet region, and
a shower main body including the shower outlet region and being connected to the shower inlet body,
wherein the flow restriction device is disposed within the shower connecting body.

11. The flow restriction device according to claim 1, wherein the webs of said two directly adjoining web planes extend inclined to each other at an angle of at least 85°.

12. The flow restriction device according to claim 6, wherein the stacked restrictor elements include a connecting arrangement interconnecting said elements in a non-releasable manner.

13. The flow restriction device of claim 1, wherein the flow restriction device is configured for a sanitary flow path.
